(19) United States
(12) Patent Application Publication
(10) Pub. No.: US 2024/0064586 A1
(43) Pub. Date: Feb. 22, 2024

(54) COMMUNICATION SYSTEM

(71) Applicant: NEC Corporation, Minato-ku, Tokyo (JP)

(72) Inventors: Yuhua Chen, Surrey (GB); Hisashi Futakl, Tokyo (JP)

(73) Assignee: NEC Corporation, Minato-ku, Tokyo (JP)

(21) Appl. No.: 18/270,752

(22) PCT Filed: Jan. 11, 2022
(86) PCT No.: PCT/JP2022/000474

§ 371 Date: Jul. 3, 2023

(30) Foreign Application Priority Data
Jan. 11, 2021 (GB) 2100483.3

(51) Int. Cl. H04W 36/00

(52) U.S. Cl. CPC H04W 36/0072; H04W 36/0033; H04W 84/06

(57) ABSTRACT

A communication system is disclosed in which a user equipment (UE) communicates via a Non-Terrestrial Network (NTN) comprising a plurality of cells. The UE receives, from a base station/NTN gateway, information related to switching a communication connection from a first cell to a second cell of the NTN. Based on the received information, the UE suspends the communication connection in the first cell but maintains a Radio Resource Control (RRC) configuration associated with that cell. The UE switches to the second cell based on the received information and monitors for a trigger for performing a random access procedure via the second cell for synchronisation. When the UE receives a trigger, it performs the random access procedure via the second cell and resumes the communication connection in the second cell using the RRC configuration associated with the first cell.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to handover in the so-called ‘5G’ (or ‘Next Generation’) systems employing Non-Terrestrial Networks (NTN).

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or include automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.4.0 and TS 37.340 V16.4.0 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

3GPP is also working on specifying an integrated satellite and terrestrial network infrastructure in the context of 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP Technical Report (TR) 38.811 V15.4.0 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). 3GPP TR 38.821 V16.0.0 provides further details about NTN.

Non-Terrestrial Networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals.

Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’).

For both scenarios, it has been agreed that the system information may include information that a particular cell is leaving and a new cell is coming, as an enhancement of the cell-reselection procedure for moving satellite system. Handover baseline is expected to use legacy (conditional) handover i.e. conditional reconfiguration with a synchronisation procedure at the new cell.

In case of inter-gNB radio link switch, Layer 3 (L3) handover (i.e. Radio Resource Control (RRC) reconfiguration) is necessary since the two base stations have independent radio resource management. In case of intra-gNB radio link switch, the same base station serves the same area before and after feeder/service link switching. However, since the ‘bending pipe’ communication link between base station and UE (i.e. the gNB-satellite feeder link and the satellite-UE service link) changes, the UE still needs to perform synchronization with the new beam although it may be possible to keep the RRC configuration from before the switching.

The inventors have identified a number of issues relating to service/feeder link change. For example, at feeder/service link change, a large number of UEs (i.e. all connected UEs in cell coverage) needs to perform handover at the same time. Thus, the legacy handover procedure needs to be enhanced for further signalling and interruption reduction.

### SUMMARY OF INVENTION

Accordingly, the present invention seeks to provide methods and associated apparatus that address or at least alleviate (at least some of) the above described issues.

Although for efficiency of understanding for those of skill in the art, the invention will be described in detail in the context of a 3GPP system (5G networks including NTN), the principles of the invention can be applied to other systems as well.

In one example aspect, the invention provides a method performed by a user equipment (UE) configured to communicate via a Non-Terrestrial Network (NTN) including a plurality of cells, the method including: receiving, from a network node, information related to switching a communication connection from a first cell to a second cell of the NTN; suspending, based on the received information, the communication connection in the first cell and maintaining a Radio Resource Control (RRC) configuration associated with the first cell; performing a cell switching based on the received information to select the second cell; receiving a trigger for performing a random access procedure via the second cell; and resuming the communication connection using the RRC configuration associated with the first cell, in the second cell, after successful completion of the random access procedure.

In one example aspect, the invention provides a method performed by a user equipment (UE) configured to communicate via a Non-Terrestrial Network (NTN) including a plurality of cells, the method including: receiving, from a network node, a Radio Resource Control (RRC) reconfiguration message including information related to switching a communication connection from a first cell to a second cell of the NTN and information relating to an RRC configuration to be applied in the second cell; performing a cell switching based on the received information to select the second cell; receiving a trigger for performing a random access procedure via the second cell; and resuming the communication connection in the second cell, using the RRC configuration, after successful completion of the random access procedure.

In one example aspect, the invention provides a method performed by a network node configured to communicate with items of user equipment (UE) via a Non-Terrestrial Network (NTN) including a plurality of cells, the method including: transmitting, to at least one UE, information related to switching a communication connection from a first cell to a second cell of the NTN for use by the at least one UE in performing a cell switching to select the second cell; maintaining a Radio Resource Control (RRC) configuration associated with the first cell when the UE suspends the communication connection in the first cell; transmitting a trigger for the at least one UE to initiate a random access procedure via the second cell; and resuming the communication connection using the RRC configuration associated with the first cell, in the second cell, after successful completion of the random access procedure.

In one example aspect, the invention provides a method performed by a network node configured to communicate with items of user equipment (UE) via a Non-Terrestrial Network (NTN) including a plurality of cells, the method including: transmitting, to at least one UE, a Radio Resource Control (RRC) reconfiguration message including information related to switching a communication connection from a first cell to a second cell of the NTN and information relating to an RRC configuration to be applied in the second cell; transmitting a trigger for the at least one UE to initiate a random access procedure via the second cell; and resuming the communication connection in the second cell, using the RRC configuration, after successful completion of the random access procedure.

In one example aspect, the invention provides a user equipment (UE) configured to communicate via a Non-Terrestrial Network (NTN) including a plurality of cells, the UE including a controller and a transceiver, wherein the controller is configured to: receive, from a network node, information related to switching a communication connection from a first cell to a second cell of the NTN; suspend, based on the received information, the communication connection in the first cell and maintain a Radio Resource Control (RRC) configuration associated with the first cell; perform a cell switching based on the received information to select the second cell; receive a trigger for performing a random access procedure via the second cell; and resume the communication connection using the RRC configuration associated with the first cell, in the second cell, after successful completion of the random access procedure.

In one example aspect, the invention provides a user equipment (UE) configured to communicate via a Non-Terrestrial Network (NTN) including a plurality of cells, the UE including a controller and a transceiver, wherein the controller is configured to: receive, from a network node, a Radio Resource Control (RRC) reconfiguration message including information related to switching a communication connection from a first cell to a second cell of the NTN and information relating to an RRC configuration to be applied in the second cell; perform a cell switching based on the received information to select the second cell; receive a trigger for performing a random access procedure via the second cell; and resume the communication connection in the second cell, using the RRC configuration, after successful completion of the random access procedure.

In one example aspect, the invention provides a network node configured to communicate with items of user equipment (UE) via a Non-Terrestrial Network (NTN) including a plurality of cells, the network node including a controller and a transceiver, wherein the controller is configured to: transmit, to at least one UE, information related to switching a communication connection from a first cell to a second cell of the NTN for use by the at least one UE in performing a cell switching to select the second cell; maintain a Radio Resource Control (RRC) configuration associated with the first cell when the UE suspends the communication connection in the first cell; transmit a trigger for the at least one UE to initiate a random access procedure via the second cell; and resume the communication connection using the RRC configuration associated with the first cell, in the second cell, after successful completion of the random access procedure.

In one example aspect, the invention provides a network node configured to communicate with items of user equipment (UE) via a Non-Terrestrial Network (NTN) including a plurality of cells, the network node including a controller and a transceiver, wherein the controller is configured to: transmit, to at least one UE, a Radio Resource Control (RRC) reconfiguration message including information related to switching a communication connection from a first cell to a second cell of the NTN and information relating to an RRC configuration to be applied in the second cell; transmit a trigger for the at least one UE to initiate a random access procedure via the second cell; and resume the communication connection in the second cell, using the RRC configuration, after successful completion of the random access procedure.

In one example aspect, the invention provides a user equipment (UE) configured to communicate via a Non-Terrestrial Network (NTN) including a plurality of cells, the UE including: means for receiving, from a network node, information related to switching a communication connection from a first cell to a second cell of the NTN; means for suspending, based on the received information, the communication connection in the first cell and for maintaining a Radio Resource Control (RRC) configuration associated with the first cell; means for performing a cell switching based on the received information to select the second cell; means for receiving a trigger for performing a random access procedure via the second cell; and means for resuming the communication connection using the RRC configuration associated with the first cell, in the second cell, after successful completion of the random access procedure.

In one example aspect, the invention provides a user equipment (UE) configured to communicate via a Non-Terrestrial Network (NTN) including a plurality of cells, the UE including: means for receiving, from a network node, a Radio Resource Control (RRC) reconfiguration message including information related to switching a communication connection from a first cell to a second cell of the NTN and information relating to an RRC configuration to be applied in the second cell; means for performing a cell switching based on the received information to select the second cell; means for receiving a trigger for performing a random access procedure via the second cell; and means for resuming the communication connection in the second cell, using the RRC configuration, after successful completion of the random access procedure.

In one example aspect, the invention provides a network node configured to communicate with items of user equipment (UE) via a Non-Terrestrial Network (NTN) including a plurality of cells, the network node including: means for transmitting, to at least one UE, information related to switching a communication connection from a first cell to a second cell of the NTN for use by the at least one UE in performing a cell switching to select the second cell; means for maintaining a Radio Resource Control (RRC) configuration associated with the first cell when the UE suspends the communication connection in the first cell; means for transmitting a trigger for the at least one UE to initiate a random access procedure via the second cell; and means for resuming the communication connection using the RRC configuration associated with the first cell, in the second cell, after successful completion of the random access procedure.

In one example aspect, the invention provides a network node configured to communicate with items of user equipment (UE) via a Non-Terrestrial Network (NTN) including a plurality of cells, the network node including: means for transmitting, to at least one UE, a Radio Resource Control (RRC) reconfiguration message including information related to switching a communication connection from a first cell to a second cell of the NTN and information relating to an RRC configuration to be applied in the second cell; means for transmitting a trigger for the at least one UE to initiate a random access procedure via the second cell; and means for resuming the communication connection in the second cell, using the RRC configuration, after successful completion of the random access procedure.

Example aspects of the invention extend to corresponding systems, apparatus, and computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the invention will now be described, by way of example, with reference to the accompanying drawings in which:

FIG. 1 illustrates schematically a mobile (cellular or wireless) telecommunication system to which example embodiments of the invention may be applied;

FIG. 2 illustrates schematically an exemplary feeder link switch scenario;

FIG. 3 illustrates schematically an exemplary feeder link switch scenario;

FIG. 4 illustrates schematically an exemplary feeder link switch scenario;

FIG. 5 is a schematic block diagram of a mobile device forming part of the system shown in FIG. 1;

FIG. 6 is a schematic block diagram of an NTN node (e.g. satellite/UAS platform) forming part of the system shown in FIG. 1;

FIG. 7 is a schematic block diagram of an access network node (e.g. base station) forming part of the system shown in FIG. 1;

FIG. 8 is a signalling (timing) diagram illustrating an exemplary way in which handover may be performed in accordance with example embodiments of the present invention;

FIG. 9 is a signalling (timing) diagram illustrating an exemplary way in which handover may be performed in accordance with example embodiments of the present invention;

FIG. 10 is a signalling (timing) diagram illustrating an exemplary way in which handover may be performed in accordance with example embodiments of the present invention;

FIG. 11 is a signalling (timing) diagram illustrating an exemplary way in which handover may be performed in accordance with example embodiments of the present invention;

FIG. 12 is a signalling (timing) diagram illustrating an exemplary way in which handover may be performed in accordance with example embodiments of the present invention;

FIG. 13 is a signalling (timing) diagram illustrating an exemplary way in which handover may be performed in accordance with example embodiments of the present invention; and

FIG. 14 illustrates schematically some exemplary architecture options for the provision of NTN features in the system shown in FIG. 1.

### DESCRIPTION OF EMBODIMENTS

Overview

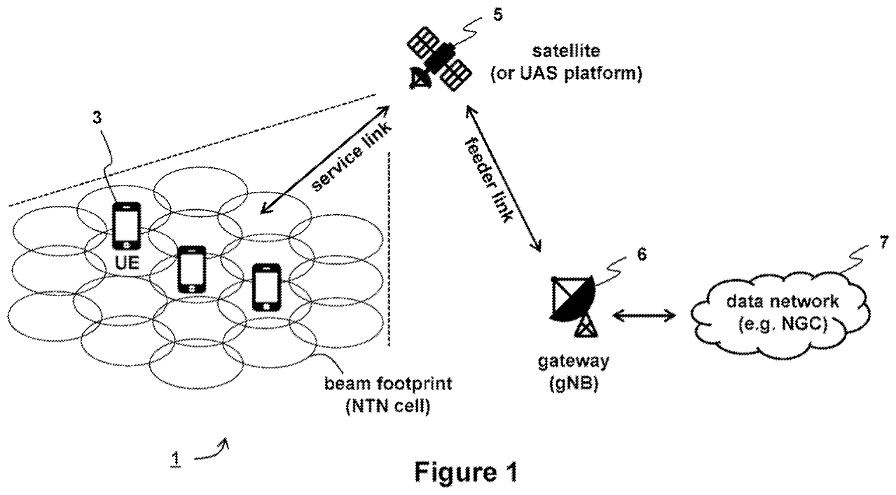

FIG. 1 illustrates schematically a mobile (cellular or wireless) telecommunication system 1 to which example embodiments of the invention may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an E-UTRA and/or 5G RAT. As those skilled in the art will appreciate, whilst three mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA and/or 5G communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit.

Alternatively, the beam footprint may be earth fixed, in which case an appropriate beam pointing mechanism (mechanical or electronic steering) may be used to compensate for the movement of the NTN node 5.

From the mobile device's point of view, cell changes happen regularly at discrete intervals due to service/feeder link switching necessitated by movement of the NTN nodes 5 along their orbit. Similarly, from the gateway point of view, feeder link changes happen at regular intervals due to the satellites' movement along their orbit. Both service and feeder link changes may be performed between different base stations/gateways (herein referred to as an ‘inter-gNB radio link switch’) or within the same base station/gateway (‘intra-gNB radio link switch’).

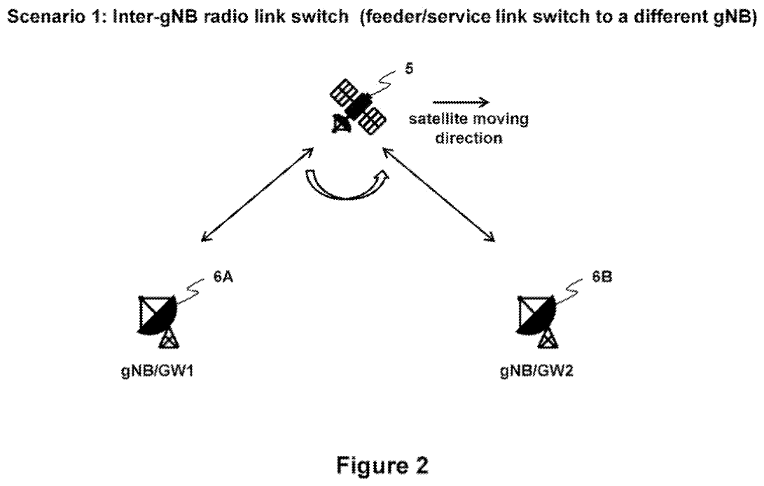

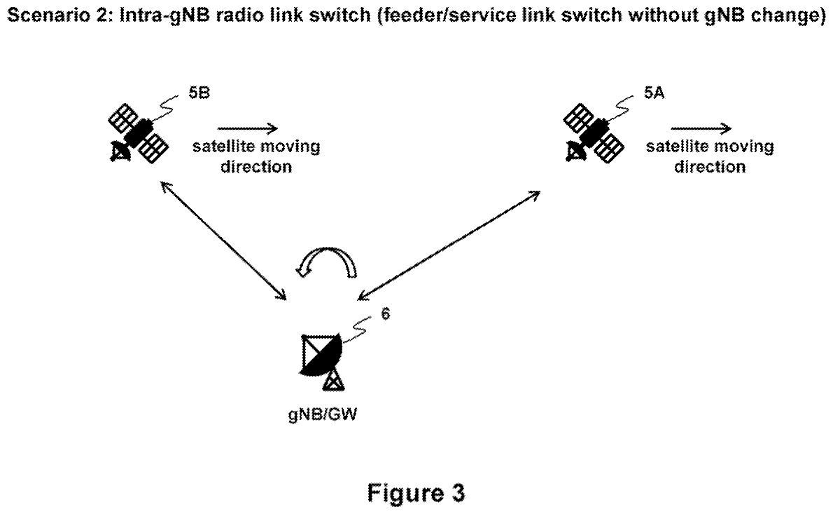

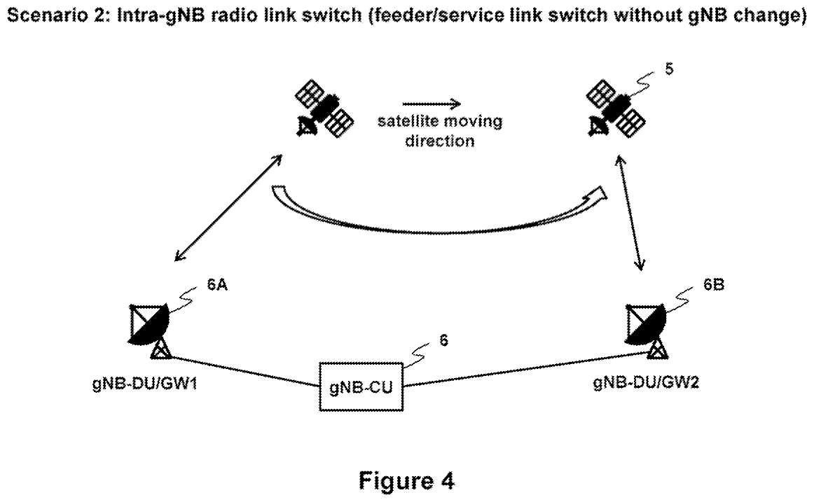

FIG. 2 illustrates schematically an exemplary inter-gNB feeder link switch scenario (feeder/service link switch with gNB/gateway change), and FIGS. 3 and 4 illustrate two possible intra-gNB feeder link switch scenarios (feeder/service link switch without gNB change). In FIG. 3 the base station 6 switches from a first (old) satellite 5A to a second (new) satellite 5B and in FIG. 4 the base station 6 switches from a first gateway to a second gateway for the same satellite 5 (the two gateways being provided via respective distributed units of the base station apparatus 6).

In order to facilitate handover of the mobile devices 3 served via the NTN nodes 5, the system information transmitted by the base station 6 (via the NTN nodes 5) includes information (e.g. an appropriate system information block/information element) indicating that a particular cell is leaving and a new cell is coming. Thus, handover of a large number of mobile devices 3 may be performed efficiently when feeder/service link switch happens.

In case of an intra-gNB radio link switch, the mobile device 3 is not required to perform a Layer 3 handover (as in case of normal handovers between neighbouring cells). Instead, the base station 6/NTN node 5 serving the mobile device 3 instructs the mobile device 3 to perform synchronisation with the new cell and resume its RRC connection at the new cell using the same Layer 2 protocol states and RRC configurations as in the old NTN cell. In more detail, upon leaving the old NTN cell, the mobile device 3 stops transmission of uplink data and reselects to an appropriate new cell. The mobile device 3 performs synchronisation with the new cell via a Random Access Channel (RACH) procedure, after which it is able to resume transmission in the new cell.

In case of inter-gNB radio link switch, the source and target base stations 6 (i.e. the source and target gateways for the NTN node 5) are configured to maintain, for a mobile device 3 being handed over, the same UE context before and after link change so that the mobile device 3 does not need to perform Layer 3 handover signalling. In case of multiple mobile devices 3 being handed over, the source base station 6 may be able to relocate all associated UE context to the target base station 6 in one go. The rest of the handover procedure (synchronisation and resumption of communication) is the same as in the case of intra-gNB radio link switch.

Beneficially, the nodes of this system are configured to spread out the signalling load resulting from handover of a large number of mobile devices 3 at feeder/service link change. This may be achieved, for example, using one or more of the following options:
1) using PDCCH orders: The source base station 6 may send legacy Physical Downlink Control Channel (PDCCH) orders to all connected UEs 3 in a distributed manner (sent to different UEs 3 at different times) for load balancing purposes. In this case, the legacy PDCCH order may be used to trigger a RACH procedure and synchronisation with the new cell.
2) using a group/common PDCCH order: a common/group PDCCH order may be sent to all UEs 3 or a group of UEs 3 (identified by an associated common/group RNTI value).
3) using a MAC CE: information relevant to random access (synchronisation) may be carried within a suitable Medium Access Control (MAC) Control Element (CE).
4) using RRC signalling: The source base station 6 may send information relevant to cell switch using a suitable conditional RRC reconfiguration information element (via an RRC reconfiguration message) or using an appropriate group handover command message (via broadcasting).

User Equipment (UE)

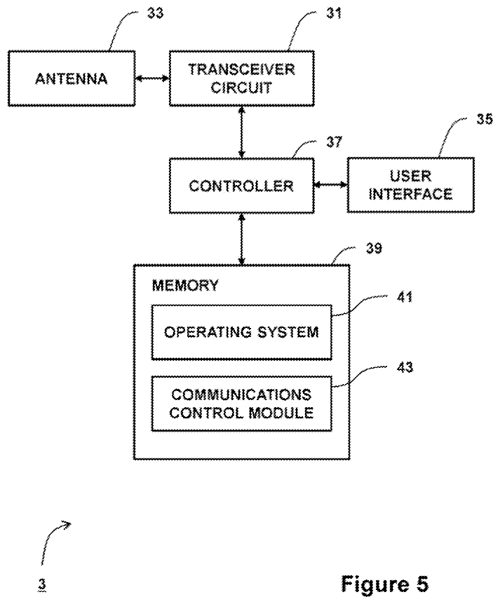

FIG. 5 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 5, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, and a communications control module 43.

The communications control module 43 is responsible for handling (generating/sending/receiving) signalling messages and uplink/downlink data packets between the UE 3 and other nodes, including NTN nodes 5, (R)AN nodes 6, and core network nodes. The signalling may include control signalling related to handover and associated procedures (e.g. random access) due to a feeder/service link change.

NTN Node (Satellite/UAS Platform)

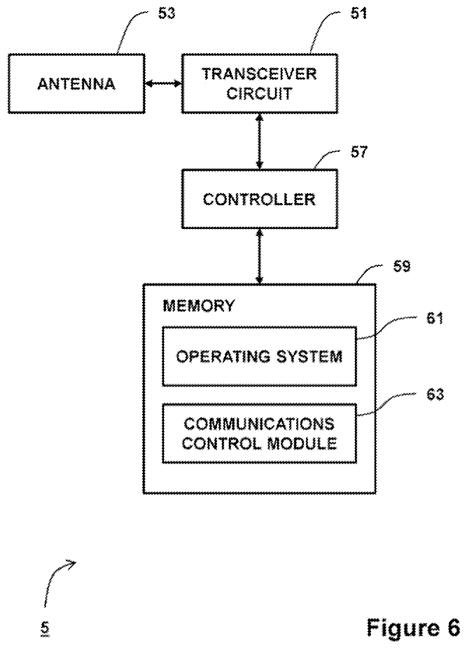

FIG. 6 is a block diagram illustrating the main components of the NTN node 5 (a satellite or a UAS platform) shown in FIG. 1. As shown, the NTN node 5 includes a transceiver circuit 51 which is operable to transmit signals to and to receive signals from connected UE(s) 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving) signalling between the NTN node 5 and other nodes, such as the UE 3, base stations 6, gateways, and core network nodes (via the base stations/gateways). The signalling may include control signalling related to handover and associated procedures (e.g. random access) due to a feeder/service link change.

Base Station/Gateway (Access Network Node)

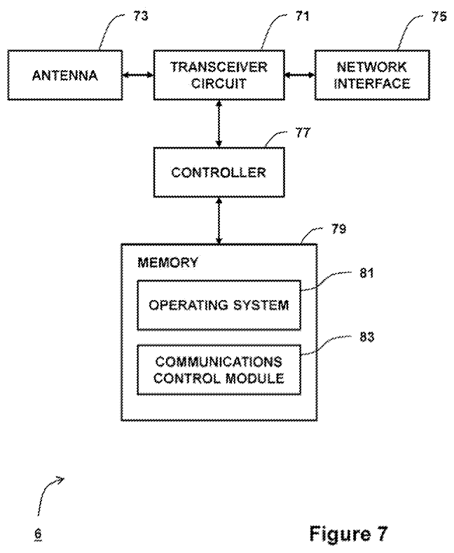

FIG. 7 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station—base station interface (such as X2/Xn) and an appropriate base station—core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the base station 6 and other nodes, such as the UE 3, NTN nodes 5, and core network nodes. The signalling may include control signalling related to handover and associated procedures (e.g. random access) due to a feeder/service link change.

### DETAILED DESCRIPTION

As illustrated in FIGS. 2 to 4, the following feeder/service link change scenarios are possible:
Scenario 1: inter-gNB radio link switch (feeder link switch to a different gNB)
   In this case the satellite 5 initially connects to a first (source) base station/gateway 6A, then it subsequently connects to a second (target) base station/gateway 6B, serving the same area.
Scenario 2: intra-gNB radio link switch (service link switch, or feeder link switch without gNB change)

For all scenarios, the system information may include information that a particular cell is leaving and a new cell is coming. Handover baseline is expected to use legacy (conditional) handover i.e. conditional reconfiguration with a synchronisation procedure at the new cell.

In case of an intra-gNB radio link switch (Scenario 2 above), the base station 6/NTN node 5 serving the mobile device 3 instructs the mobile device 3 to perform synchronisation with the new cell and resume its RRC connection at the new cell using the same Layer 2 protocol states and RRC configurations as in the old NTN cell. The mobile device 3 stops transmission in the leaving NTN cell, reselects to the new NTN cell (i.e. a different beam), performs synchronisation with the new cell by performing an appropriate RACH procedure, after which it is able to resume transmission in the new cell using the same Layer 2 protocol states and RRC configurations as in the old cell.

Beneficially, this approach does not require Layer 3 handover procedures and makes it possible to avoid associated signalling.

The following is a description of some exemplary ways (Solutions 1 to 5) in which the above procedure may be implemented in the system shown in FIG. 1.

Solution 1—PDCCH Order Based

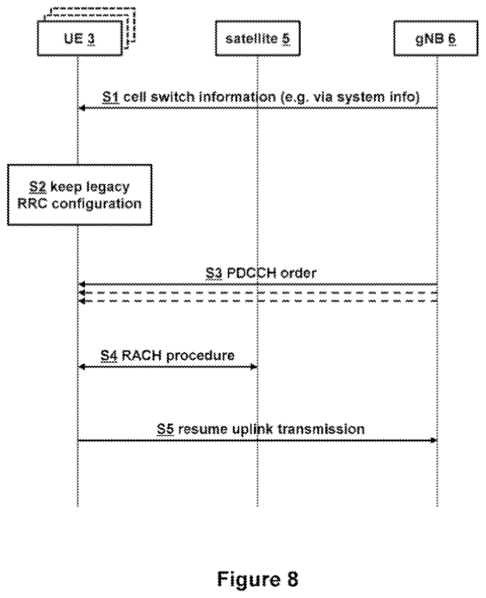

FIG. 8 is a signalling (timing) diagram illustrating an exemplary procedure for performing handover without RRC reconfiguration (in case of an intra-gNB radio link switch). This procedure is based on PDCCH orders and includes the following steps:
S1. The base station 6 (gNB) transmits information to the mobile device 3 that is relevant to cell switching. The information may include information (implicitly or explicitly) that the current NTN cell is going, a new NTN cell is coming, and/or an indication that an intra-gNB cell switching is to be performed without RRC reconfiguration. The information may be transmitted via broadcast or by transmitting an appropriate dedicated RRC message (or a combination of the two). The information may be transmitted to all mobile devices 3 (at least connected mode UEs) that need to hand over to a new NTN cell.
   In this example, the base station 6 transmits to the mobile device 3 information relating to the following:
      Timing of cell switching (handover); and
      New cell PCI/SSB pattern (SSB raster).
S2. At the indicated/calculated cell switch time, the mobile device 3 keeps its current RRC configuration and protocol states. The mobile device 3 also performs the following in preparation for handover:
   at the MAC layer, the mobile device 3 may expire a time alignment timer (TAT) associated with the current cell, hence uplink transmissions are suspended;
   perform cell selection (switching) to the indicated new NTN cell; and
   continue monitoring PDCCH addressed to its old cell specific Radio Network Temporary Identifier (C-RNTI).

Beneficially, step S2 may be performed by all connected mode UEs that need to hand over to a new NTN cell (at the time indicated in step S1, e.g. either substantially concurrently or at a specific time indicated per UE).
S3. After the feeder/service link change is complete, the base station 6 (gNB) sends legacy PDCCH orders to all connected mode UEs 3. The PDCCH orders may be transmitted in a distributed manner (sent to different UEs at different time) for load balancing purposes. The legacy PDCCH order is used to trigger a UE to perform a RACH procedure. A dedicated preamble can be indicated via the PDCCH order (unless ra-PreambleIndex is set to 0b000000, in which case a contention based RACH procedure may be used). The next two solutions describe possible modifications that allow triggering a group of UEs initiating Random Access Procedures in one go.
S4. Based on (i.e. upon receipt of) the PDCCH order addressed to the mobile device 3 (by its C-RNTI), the mobile device 3 performs an appropriate RACH procedure in order to resync with the new NTN cell.
S5. After successful completion of the random access procedure, the mobile device 3 resumes uplink transmissions using the same configuration and the same protocol states. Thus, the mobile device 3 does not need to change its security parameters and does not need to perform procedures for establishment of Radio Link Control (RLC) and Packet Data Convergence Protocol (PDCP) layer connections.

Solution 2—Group/Common PDCCH Order

This solution is effectively the same as Solution 1 but with following changes:
A new RNTI value (common for all UEs or common for a group of UEs) is defined/configured in step S1.
The UEs 3 monitor the configured/defined RNTI (instead of C-RNTI) in step S2.
A common/group PDCCH order is sent to all UEs or the group of UEs in step S3. The common PDCCH order includes information indicating which UE needs to use which RA resource when subsequently initiating the corresponding Random Access procedure in step S4 (in order to synchronise with the new NTN cell). For example, the information included in the common/group PDCCH order may be in the form of a list such as:
   a list of {UE identity #1 e.g. C-RNTI, preambleindex, PRACH Mask Index(optional)}
Step S4 is performed based on (upon receipt of) the group PDCCH order addressed to all mobile devices 3 or the group of the mobile devices 3 (by the RNTI).

Step S5 is the same as in Solution 1.

Solution 3—MAC CE RA Order

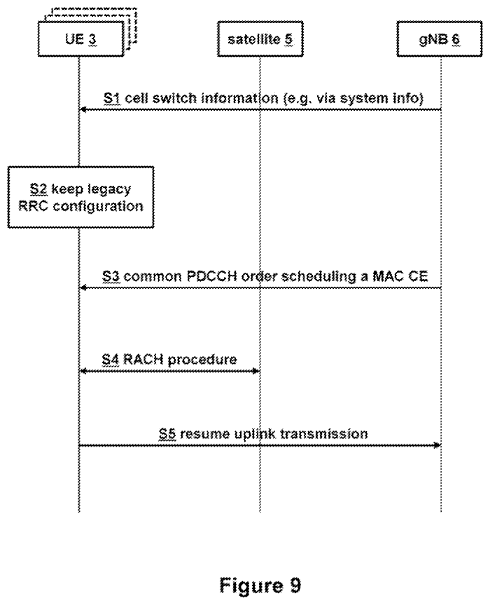

FIG. 9 is a signalling (timing) diagram illustrating another exemplary procedure for performing handover without RRC reconfiguration (in case of an intra-gNB radio link switch). The procedure is similar to Solution 2, but the information relevant to random access is carried within a suitable Medium Access Control (MAC) Control Element (CE) instead of the PDCCH order (in order to avoid a potential limitation on the size of the PDCCH payload).

In this example, the information transmitted in step S1 includes a new RNTI value (common for all UEs or common for a group of UEs). The UEs 3 (connected UEs) monitor the configured/defined RNTI in step S2. In step S3, the common PDCCH schedules a PDSCH transmission which carries an appropriate MAC CE that indicates which UE needs to use which random access resource when initiating a Random Access procedure for synchronising with the new NTN cell. In this example, the MAC CE includes the following random access related information:
a list of {UE identity #1 e.g. C-RNTI, preambleindex, PRACH Mask Index(optional)}

Step S4 is performed based on the information included in the MAC CE (i.e. upon receipt of the MAC CE). Step S5 is the same as in Solution 1.

Solution 4—RRC Signal Based

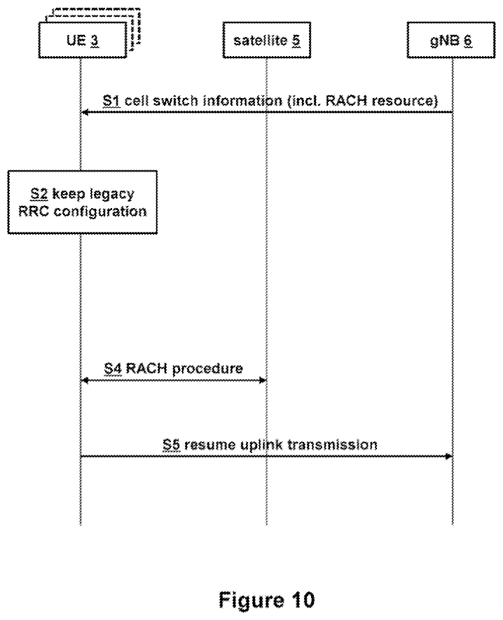

FIG. 10 is a signalling (timing) diagram illustrating yet another exemplary procedure for performing handover without RRC reconfiguration (in case of an intra-gNB radio link switch). The procedure uses RRC signalling and includes the following steps:
S1. The base station 6 (gNB) transmits information to the mobile device 3 that is relevant to cell switching. The information may be transmitted using an appropriate RRC message or using a group handover command/cell switch message (which may be transmitted via broadcasting). The information may be transmitted to all mobile devices 3 (at least connected mode UEs) that need to hand over to a new NTN cell.
   In this example, the base station 6 transmits to the mobile device 3 information relating to the following:
      Timing of cell switching (handover);
      New cell PCI/SSB pattern (SSB raster);
      an indication (implicit or explicit) that an intra-gNB handover is to be performed at lower layers only (i.e. without further Layer 3 signalling); and
      information identifying an appropriate RACH resource to be used (may also include a back off value for load control);
S2. At the indicated/calculated cell switch time, the mobile device 3 keeps its current RRC configuration and protocol states. The mobile device 3 also performs the following in preparation for handover:
   at the MAC layer, the mobile device 3 may expire a time alignment timer (TAT) associated with the current cell, hence uplink transmissions are suspended; and
   perform cell selection (switching) to the indicated new NTN cell.
It will be appreciated that step S2 may be performed by all connected mode UEs that need to hand over to a new NTN cell, at the time indicated in step S1 (which may or may not be at the same time).

In this example, there is no need for the base station 6 (gNB) to send any additional signalling (e.g. legacy PDCCH orders/MAC CE) to trigger synchronisation with the new NTN cell. Thus, step S3 may be omitted.
S4. The mobile device 3 performs an appropriate RACH procedure in order to resync with the new NTN cell using the RACH resource configured via the RRC signalling in step S1.
S5. After successful completion of the random access procedure, the mobile device 3 resumes uplink transmissions using the same configuration and the same protocol states that were applicable for the old NTN cell.

Solution 5—Hybrid (RRC+Group/Common PDCCH/MAC CE Order)

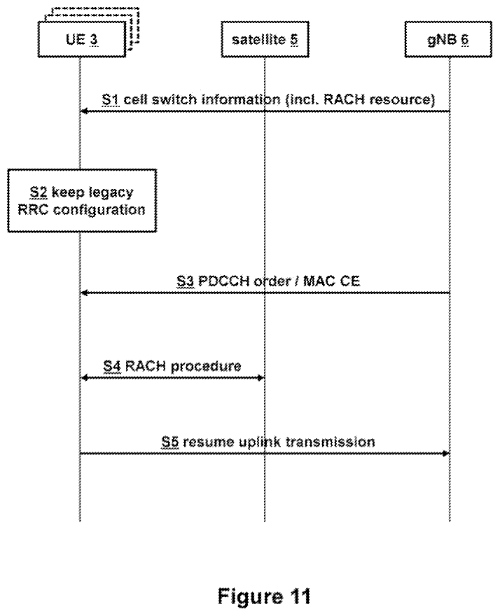

FIG. 11 is a signalling (timing) diagram illustrating another exemplary procedure which is a combination of Solution 4 and either Solution 2 or 3. The procedure includes the following steps:
S1. Step S1 is the effectively the same as described above for Solution 4. However, in this case the information transmitted using an RRC message or a group handover command/cell switch message also includes information identifying an appropriate group C-RNTI for a group of UEs (or a common C-RNTI for all UEs).
S2. This step is effectively the same as step S2 of Solution 2. The UEs 3 monitor the group/common C-RNTI.
S3. The base station 6 sends a common/group PDCCH order (as in Solution 2) or a MAC CE RA order (as in Solution 3) addressed by the configured common/group C-RNTI. However, it will be appreciated that this PDCCH order/MAC CE RA order may be simpler than the one in Solutions 1 to 3 since the appropriate RACH resources have been preconfigured in step S1.

Steps S4 and S5 are the same as described above.

Solution 6—UE Context Relocation

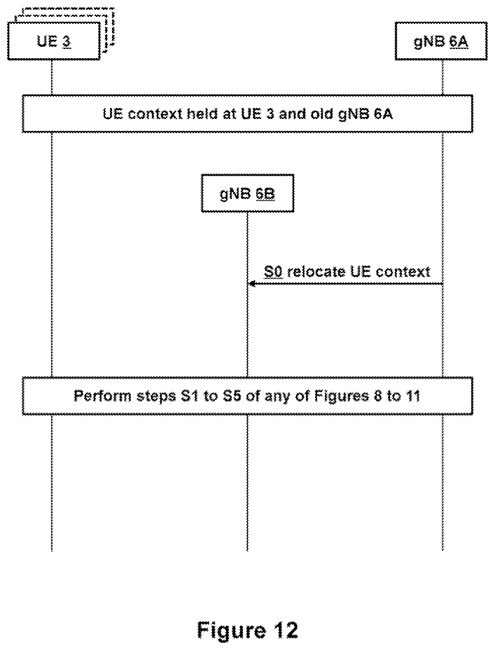

FIG. 12 is a signalling (timing) diagram illustrating an exemplary procedure for performing handover without RRC reconfiguration (in case of an inter-gNB radio link switch).

In this case, the source and target base stations 6 (i.e. the source and target gateways for the NTN node 5) are configured to maintain, for each mobile device 3 being handed over, the associated UE context so that the mobile devices 3 do not need to perform Layer 3 handover signalling. In other words, the UE context may be the same before and after handover.

Beneficially, the source base station 6A may be configured to relocate the UE context associated with the mobile device 3 (as generally illustrated in step S0 of FIG. 12). When multiple mobile devices 3 need to be handed over, the source base station 6 may be configured to relocate all associated UE contexts to the target base station 6 at the same time (e.g. using a single UE context relocation message or a series of UE context relocation messages).

The rest of the procedure (synchronisation and resumption of communication) may be implemented in a similar manner as described above for the intra-gNB radio link switch case.

Beneficially, this approach also does not require Layer 3 handover procedures and makes it possible to avoid or minimise associated signalling.

Solution 7—Hybrid (RRC+Group/Common PDCCH/MAC CE RA Order)

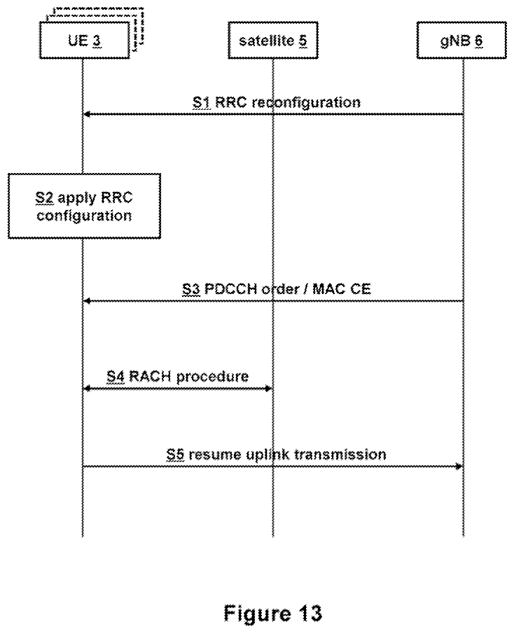

FIG. 13 is a signalling (timing) diagram illustrating an exemplary procedure for performing handover using RRC reconfiguration. This procedure may be applied for both intra-gNB radio link switch and inter-gNB radio link switch.

Effectively, this procedure re-uses the existing Layer 3 handover procedure, i.e. RRC Reconfiguration with synchronisation, with the following difference:
In this case the UE 3 monitors PDCCH order/MAC CE RA order for triggering the random access procedure, instead of starting random access immediately upon cell reselection (as in case of legacy Layer 3 handovers). Accordingly, the base station 6 is able to control the timing of handover per UE or per UE group using an appropriately formatted PDCCH order or a MAC CE RA order.

In more detail, the procedure includes the following steps:
S1. The base station 6 (gNB) transmits information to the mobile device 3 that is relevant to cell switching. In this case the information is transmitted using an appropriate conditional RRC reconfiguration information element via an RRC reconfiguration message or using a group handover command message (which may be transmitted via broadcasting). The information may be transmitted to all (or a group of) mobile devices 3 that need to hand over to a new NTN cell.
   In this example, the base station 6 transmits to the mobile device 3 information relating to the following:
      Timing of cell switching (handover);
      New cell PCI/SSB pattern (SSB raster);
      RRC reconfiguration (conditional handover or normal handover); and
      information identifying an appropriate RACH resource to be used and/or a back off value for load control; and
      a group/common C-RNTI (as in Solution 2).

It will be appreciated that the information identifying the RACH resource is optional. If this information is not provided, the mobile device 3 will perform a contention based random access procedure via the new cell.
S2. At the indicated/calculated cell switch time, the mobile device 3 applies the received RRC configuration and performs the following in preparation for handover:
   perform cell selection (switching) to the indicated new NTN cell; and
   starts monitoring PDCCH address to the configured common/group C-RNTI.
S3. The base station 6 sends a common/group PDCCH order (as in Solution 2) or a MAC CE RA order (as in Solution 3) addressed by the common/group C-RNTI. Beneficially, this PDCCH order/MAC CE RA order may be simpler than the one in Solutions 1 to 3 since the appropriate RACH resources have been preconfigured in step S1.
S4. After receiving a corresponding PDCCH order/MAC CE RA order, the mobile device 3 performs an appropriate RACH procedure in order to resync with the new NTN cell.
S5. After successful completion of the random access procedure, the mobile device 3 resumes uplink transmissions in via the new NTN cell using the applicable new RRC configuration.

Modifications and Alternatives

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

The above description uses the term ‘cell selection’ or ‘cell switching’ when referring to the UE selecting a new cell. This term is intended to cover legacy cell selection methods (e.g. idle mode cell selection as defined in 3GPP TS in 38.304 V16.3.0) and other similar mechanisms by which the UE leaves one cell and camps on another cell in preparation for re-connection via that cell.

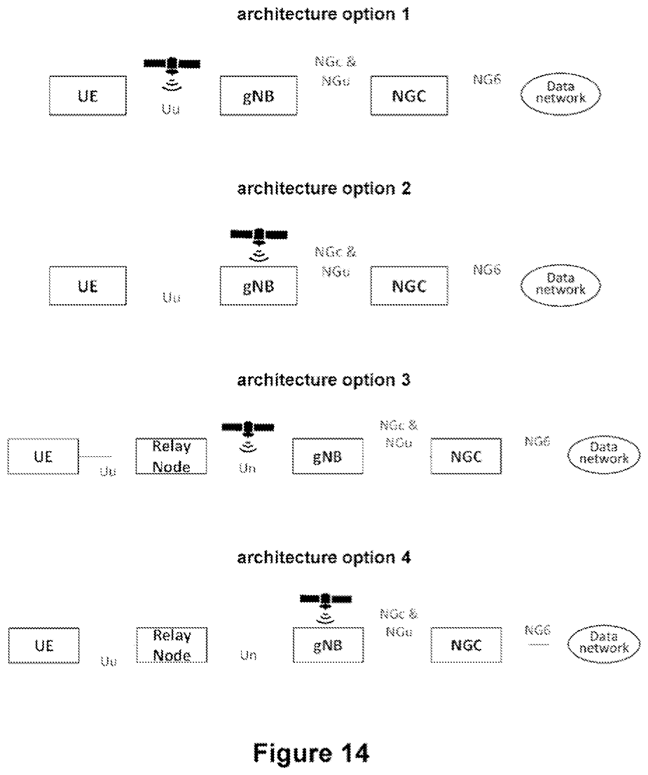

It will be appreciated that cell selection may be the same or a similar process as the legacy or existing cell selection process in 5G NR, LTE, or 3G, or other radio access technology. However, cell selection may be achieved by cell switching or synchronising to the downlink of a target cell. Cell switching may be performed, for example, in a way that the UE switches its serving or camping cell from one cell to another cell according to the RRC configuration received from the network node/base station apparatus. The synchronising may be performed, for example, in a way that the UE achieves synchronization to the downlink of the target cell, and it is able to receive necessary system information via that cell. However, the UE may omit reading the Master Information Block (MIB) if the UE already has the required timing information, or the timing information is not needed for random access. It will be appreciated that there are various architecture options to implement NTN in a 5G system, some of which are illustrated schematically in FIG. 14. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may include a satellite/UAS.

TABLE 1
types of satellites and UAS platforms

| | | | Typical beam |
|---|---|---|---|
| Platforms | Altitude range | Orbit | footprint size |
| Low-Earth Orbit | 300~1500 km | Circular around | 100-1000 km |
| (LEO) satellite | | the earth | |
| Medium-Earth | 7000-25000 km | | 100-1000 km |
| Orbit (MEO) | | | |
| satellite | | | |
| Geostationary | 35 786 km | Notional station | 200-3500 km |
| Earth Orbit | | keeping position | |
| (GEO) satellite | | fixed in terms of | |
| UAS platform | 8-50 km | elevation/azimuth | 5-200 km |
| (including HAPS) | (20 km for | with respect to a | |
| | HAPS) | given earth point | |
| High Elliptical | 400-50000 km | Elliptical around | 200~3500 km |
| Orbit (HEO) | | the earth | |
| satellite | | | |

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may include any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above example embodiments are also applicable to ‘non-mobile’ or generally stationary user equipment. The above described mobile device may include an MTC/IoT device and/or the like.

The method may include receiving the information related to switching a communication connection from a first cell to a second cell of the NTN in at least one of an RRC message, a group handover command message, a cell switch message, and system information/broadcast signalling. The information may be included in a conditional RRC reconfiguration information element.

The trigger may include at least one of a Physical Downlink Control Channel (PDCCH) order and a Medium Access Control (MAC) Control Element (CE).

The trigger may include information identifying a random access preamble for the UE (e.g. a list of UE identities and information identifying respective random access preambles) and the method may include performing the random access procedure using the random access preamble so identified.

The information related to switching from a first cell to a second cell of the NTN may include information identifying a timing related to the switching and a Physical Cell Identity (PCI) associated with the second cell and/or a Synchronization Signal/Physical Broadcast Channel block (SSB) pattern associated with the second cell.

The information related to switching from a first cell to a second cell of the NTN may include information identifying a resource to be used by the UE for a random access procedure via the new cell and the method may include performing the random access procedure using the resource so identified.

The information related to switching from a first cell to a second cell of the NTN may include an identifier for a plurality of UEs including the UE (e.g. a group/common cell specific Radio Network Temporary Identifier, C-RNTI) and the trigger may be addressed to the identifier.

The information related to switching from a first cell to a second cell of the NTN may include an indication that an intra-gNB cell switching is to be performed without RRC reconfiguration.

The network node may include a gateway or a base station (e.g. a target base station).

The method may further include relocating a UE context associated with the UE from another network node controlling the first cell before resuming the communication connection in the second cell.

Various other modifications will be apparent to those skilled in the art and will not be described in further detail here.

The whole or part of the example embodiments disclosed above can be described as, but not limited to, the following supplementary notes.

(Supplementary Note 1)

A method performed by a user equipment (UE) configured to communicate via a Non-Terrestrial Network (NTN) including a plurality of cells, the method including:
receiving, from a network node, information related to switching a communication connection from a first cell to a second cell of the NTN;
suspending, based on the received information, the communication connection in the first cell and maintaining a Radio Resource Control (RRC) configuration associated with the first cell;
performing a cell switching based on the received information to select the second cell;
receiving a trigger for performing a random access procedure via the second cell; and
resuming the communication connection using the RRC configuration associated with the first cell, in the second cell, after successful completion of the random access procedure.

(Supplementary Note 2)

The method according to supplementary note 1, including receiving the information related to switching a communication connection from a first cell to a second cell of the NTN in at least one of an RRC message, a group handover command message, a cell switch message, and system information/broadcast signalling.

(Supplementary Note 3)

The method according to supplementary note 1 or 2, wherein the information is included in a conditional RRC reconfiguration information element.

(Supplementary Note 4)

The method according to any one of supplementary notes 1 to 3, wherein the trigger includes at least one of a Physical Downlink Control Channel (PDCCH) order and a Medium Access Control (MAC) Control Element (CE).

(Supplementary Note 5)

The method according to any one of supplementary notes 1 to 4, wherein the trigger includes information identifying a random access preamble for the UE (e.g. a list of UE identities and information identifying respective random access preambles) and the method includes performing the random access procedure using the random access preamble so identified.

(Supplementary Note 6)

The method according to any one of supplementary notes 1 to 5, wherein the information related to switching from a first cell to a second cell of the NTN includes information identifying a timing related to the switching and a Physical Cell Identity (PCI) associated with the second cell and/or a Synchronization Signal/Physical Broadcast Channel block (SSB) pattern associated with the second cell.

(Supplementary Note 7)

The method according to any one of supplementary notes 1 to 6, wherein the information related to switching from a first cell to a second cell of the NTN includes information identifying a resource to be used by the UE for a random access procedure via the new cell and the method includes performing the random access procedure using the resource so identified.

(Supplementary Note 8)

The method according to any one of supplementary notes 1 to 7, wherein the information related to switching from a first cell to a second cell of the NTN includes an identifier for a plurality of UEs including the UE (e.g. a group/common cell specific Radio Network Temporary Identifier, C-RNTI) and the trigger is addressed to the identifier.

(Supplementary Note 9)

The method according to any one of supplementary notes 1 to 8, wherein the information related to switching from a first cell to a second cell of the NTN includes an indication that an intra-gNB cell switching is to be performed without RRC reconfiguration.

(Supplementary Note 10)

The method according to any one of supplementary notes 1 to 9, wherein the network node includes a gateway or a base station apparatus.

(Supplementary Note 11)

A method performed by a user equipment (UE) configured to communicate via a Non-Terrestrial Network (NTN) including a plurality of cells, the method including:
receiving, from a network node, a Radio Resource Control (RRC) reconfiguration message including information related to switching a communication connection from a first cell to a second cell of the NTN and information relating to an RRC configuration to be applied in the second cell;
performing a cell switching based on the received information to select the second cell;
receiving a trigger for performing a random access procedure via the second cell; and
resuming the communication connection in the second cell, using the RRC configuration, after successful completion of the random access procedure.

(Supplementary Note 12)

The method according to supplementary note 11, wherein the information related to switching a communication connection from a first cell to a second cell of the NTN includes an identifier for a plurality of UEs including the UE (e.g. a group/common cell specific Radio Network Temporary Identifier, C-RNTI) and the trigger is addressed to the identifier.

(Supplementary Note 13)

The method according to supplementary note 11 or 12, wherein the trigger includes at least one of a Physical Downlink Control Channel (PDCCH) order and a Medium Access Control (MAC) Control Element (CE).

(Supplementary Note 14)

A method performed by a network node configured to communicate with items of user equipment (UE) via a Non-Terrestrial Network (NTN) including a plurality of cells, the method including:
transmitting, to at least one UE, information related to switching a communication connection from a first cell to a second cell of the NTN for use by the at least one UE in performing a cell switching to select the second cell;
maintaining a Radio Resource Control (RRC) configuration associated with the first cell when the UE suspends the communication connection in the first cell;
transmitting a trigger for the at least one UE to initiate a random access procedure via the second cell; and
resuming the communication connection using the RRC configuration associated with the first cell, in the second cell, after successful completion of the random access procedure.

(Supplementary Note 15)

A method performed by a network node configured to communicate with items of user equipment (UE) via a Non-Terrestrial Network (NTN) including a plurality of cells, the method including:
transmitting, to at least one UE, a Radio Resource Control (RRC) reconfiguration message including information related to switching a communication connection from a first cell to a second cell of the NTN and information relating to an RRC configuration to be applied in the second cell;
transmitting a trigger for the at least one UE to initiate a random access procedure via the second cell; and
resuming the communication connection in the second cell, using the RRC configuration, after successful completion of the random access procedure.

(Supplementary Note 16)

The method according to supplementary note 14 or 15, wherein the network node controls the second cell and the method further includes relocating a UE context associated with the UE from another network node controlling the first cell before resuming the communication connection in the second cell.

(Supplementary Note 17)

A user equipment (UE) configured to communicate via a Non-Terrestrial Network (NTN) including a plurality of cells, the UE including:
means for receiving, from a network node, information related to switching a communication connection from a first cell to a second cell of the NTN;
means for suspending, based on the received information, the communication connection in the first cell and for maintaining a Radio Resource Control (RRC) configuration associated with the first cell;
means for performing a cell switching based on the received information to select the second cell;
means for receiving a trigger for performing a random access procedure via the second cell; and
means for resuming the communication connection using the RRC configuration associated with the first cell, in the second cell, after successful completion of the random access procedure.

(Supplementary Note 18)

A user equipment (UE) configured to communicate via a Non-Terrestrial Network (NTN) including a plurality of cells, the UE including:
means for receiving, from a network node, a Radio Resource Control (RRC) reconfiguration message including information related to switching a communication connection from a first cell to a second cell of the NTN and information relating to an RRC configuration to be applied in the second cell;
means for performing a cell switching based on the received information to select the second cell;
means for receiving a trigger for performing a random access procedure via the second cell; and
means for resuming the communication connection in the second cell, using the RRC configuration, after successful completion of the random access procedure.

(Supplementary Note 19)

A network node configured to communicate with items of user equipment (UE) via a Non-Terrestrial Network (NTN) including a plurality of cells, the network node including:
means for transmitting, to at least one UE, information related to switching a communication connection from a first cell to a second cell of the NTN for use by the at least one UE in performing a cell switching to select the second cell;
means for maintaining a Radio Resource Control (RRC) configuration associated with the first cell when the UE suspends the communication connection in the first cell;
means for transmitting a trigger for the at least one UE to initiate a random access procedure via the second cell; and
means for resuming the communication connection using the RRC configuration associated with the first cell, in the second cell, after successful completion of the random access procedure.

(Supplementary Note 20)

A network node configured to communicate with items of user equipment (UE) via a Non-Terrestrial Network (NTN) including a plurality of cells, the network node including:
means for transmitting, to at least one UE, a Radio Resource Control (RRC) reconfiguration message including information related to switching a communication connection from a first cell to a second cell of the NTN and information relating to an RRC configuration to be applied in the second cell;
means for transmitting a trigger for the at least one UE to initiate a random access procedure via the second cell; and
means for resuming the communication connection in the second cell, using the RRC configuration, after successful completion of the random access procedure.

This application is based upon and claims the benefit of priority from United Kingdom Patent Application No. 2100483.3, filed on Jan. 14, 2021, the disclosure of which is incorporated herein in its entirety by reference.

What is claimed is:

1. A method performed by a user equipment (UE) configured to communicate via a Non-Terrestrial Network (NTN), the method comprising:
receiving, from a network node, information related to switching a connection from a first cell to a second cell of the NTN;
suspending, based on the information, the connection in the first cell while maintaining a Radio Resource Control (RRC) configuration associated with the first cell;
performing a cell switching without RRC Reconfiguration for the connection based on the information to select the second cell;
receiving a trigger for performing a random access procedure via the second cell; and
resuming the connection using the RRC configuration in the second cell without RRC Reconfiguration for the connection.

2. The method according to claim 1, wherein the information is included in at least one of:
an RRC message,
a group handover command message,
a cell switch message, and
system information/broadcast signalling.

3. The method according to claim 1, wherein the information is included in a conditional RRC reconfiguration information element.

4. The method according to claim 1, wherein the trigger includes at least one of:
a Physical Downlink Control Channel (PDCCH) order; and
a Medium Access Control (MAC) Control Element (CE).

5. The method according to claim 1, wherein
the trigger includes information identifying a random access preamble for the UE, and
the method comprises performing the random access procedure using the random access preamble.

6. The method according to claim 1, wherein the information related to switching includes information identifying a timing related to the switching and a Physical Cell Identity (PCI) associated with the second cell and/or a Synchronization Signal/Physical Broadcast Channel block (SSB) pattern associated with the second cell.

7. The method according to claim 1, wherein
the information related to switching includes information identifying a resource to be used by the UE for a random access procedure via the second cell, and
the method comprises performing the random access procedure using the resource.

8. The method according to claim 1, wherein the information related to switching includes an identifier for a plurality of UEs including the UE and the trigger is addressed to the identifier.

9. The method according to claim 1, wherein the information related to switching includes an indication that an intra-base station cell switching is to be performed without RRC reconfiguration.

10. The method according to claim 1, wherein the network node includes a gateway or a base station.

11.-13. (canceled)

14. A method performed by a network node configured to communicate with a user equipment (UE) via a Non-Terrestrial Network (NTN), the method comprising:
transmitting, to the UE, information related to switching a connection from a first cell to a second cell of the NTN for use by the UE in performing a cell switching to select the second cell;
maintaining a Radio Resource Control (RRC) configuration associated with the first cell in a case where the UE suspends the connection in the first and performs a cell switching without RRC Reconfiguration for the connection based on the information, to select the second cell;
transmitting a trigger for the UE to initiate a random access procedure via the second cell; and
resuming the connection using the RRC configuration in the second cell without RRC Reconfiguration for the connection.

15. (canceled)

16. The method according to claim 14, further comprising:
controlling the second cell; and
relocating a UE context associated with the UE from another network node controlling the first cell before resuming the connection in the second cell.

17. A user equipment (UE) configured to communicate via a Non-Terrestrial Network (NTN), the UE comprising:
a memory storing instructions; and
at least one processor configured to process the instructions to:
receive, from a network node, information related to switching a connection from a first cell to a second cell of the NTN;
suspend, based on the information, the communication connection in the first cell while maintaining a Radio Resource Control (RRC) configuration associated with the first cell;
perform a cell switching without RRC Reconfiguration for the connection based on the information to select the second cell;
receive a trigger for performing a random access procedure via the second cell; and
resume the connection using the RRC configuration in the second cell without RRC Reconfiguration for the connection.

18. (canceled)

19. A network node configured to communicate with a user equipment (UE) via a Non-Terrestrial Network (NTN), the network node comprising:
a memory storing instructions; and
at least one processor configured to process the instructions to:
transmit, to the UE, information related to switching a connection from a first cell to a second cell of the NTN for use by the UE in performing a cell switching to select the second cell;
maintain a Radio Resource Control (RRC) configuration associated with the first cell in a case where the UE suspends the connection in the first and performs a cell switching without RRC Reconfiguration for the connection based on the information, to select the second cell;
transmit a trigger for the UE to initiate a random access procedure via the second cell; and
resume the connection using the RRC configuration in the second cell without RRC Reconfiguration for the connection.

20. (canceled)
